(19) United States
(12) Patent Application Publication
(10) Pub. No.: US 2023/0350126 A1
(43) Pub. Date: Nov. 2, 2023

(54) BACKLIGHT, MULTIVIEW BACKLIGHT, AND METHOD HAVING GLOBAL MODE MIXER

(71) Applicant: LEIA INC., Menlo Park, CA (US)

(72) Inventors: David A. Fattal, Menlo Park, CA (US); Joseph D. Lowney, Tucson, AZ (US)

(21) Appl. No.: 18/207,063

(22) Filed: Jun. 7, 2023

Related U.S. Application Data
(63) Continuation of application No. PCT/US2020/067749, filed on Dec. 31, 2020.

(51) Int. Cl. F21V 8/00

(52) U.S. Cl. CPC G02B 6/0036; G02B 6/0041; G02B 6/0055

(57) ABSTRACT

Examples disclosed herein include a plate light guide configured to guide light along a length of a light guide. The light guided along the length of the light guide propagates in at least two directional modes: a first directional mode and a second directional mode. Light guided in a first directional mode has one or both of a transverse component that is greater than and a vertical component that is less than respective transverse and vertical components of light guided in the second directional mode. Also included is a global mode mixer. The global mode mixer extends along the length of the light guide length and is configured to convert a portion of the light guided in a first directional mode into a second directional mode. A scattering element preferentially scatters light in the second directional mode out of the light guide.

### CROSS-REFERENCE TO RELATED APPLICATIONS

This application is a continuation patent application of and claims priority to International Patent Application No. PCT/US2020/067749, filed Dec. 31, 2020, the entirety of which is incorporated by reference herein.

### STATEMENT REGARDING FEDERALLY SPONSORED RESEARCH OR DEVELOPMENT

N/A

### BACKGROUND

Light may propagate in a waveguide configured as a light guide, such as a plate light guide, and as it propagates along the waveguide, light may be extracted from the waveguide to be used as a source of illumination. Such waveguides configured as light guides may be used, for example, light sources for use in certain types of electronic displays.

Electronic displays may be categorized as either active displays (i.e., displays that emit light) or passive displays (i.e., displays that modulate light provided by another source). Among the most obvious examples of active displays are CRTs, PDPs and OLEDs/AMOLEDs. Displays that are typically classified as passive when considering emitted light are liquid crystal displays (LCDs) and electrophoretic (EP) displays. Passive displays, while often exhibiting attractive performance characteristics including, but not limited to, inherently low power consumption, may find somewhat limited use in many practical applications given the lack of an ability to emit light.

Passive displays may be coupled to an external light source. The coupled light source may allow these otherwise passive displays to emit light and function substantially as an active display. Examples of such coupled light sources are backlights. A backlight may serve as a source of light (often a panel backlight) that is placed behind an otherwise passive display to illuminate the passive display. For example, a backlight may be coupled to an LCD or an EP display. The backlight emits light that passes through the LCD or the EP display. The amount of light coupled to an LCD or EP display from the backlight can dictate the brightness and efficiency of a display.

### BRIEF DESCRIPTION OF THE DRAWINGS

Various features of examples and embodiments in accordance with the principles described herein may be more readily understood with reference to the following detailed description taken in conjunction with the accompanying drawings, where like reference numerals designate like structural elements, and in which:

FIG. 1A illustrates a graphical representation of angular components of a light beam having a directional mode in an example, according to an embodiment consistent with the principles described herein.

FIG. 1B illustrates a plot showing the transverse and vertical components of two example directional modes described herein.

FIG. 2A illustrates a cross-sectional view of a planar backlight having scattering structures and a global mode mixer in an example, according to an embodiment consistent with the principles described herein.

FIG. 2B illustrates a perspective view of a planar backlight having scattering structures and a global mode mixer in an example consistent with the principles defined herein.

FIG. 2C illustrates a plan view of a planar backlight having scattering structures and a global mode mixer in an example consistent with the principles described herein.

FIG. 3A illustrates a cross-sectional view of a multiview display having scattering structures and a global mode mixer in an example consistent with the principles described herein.

FIG. 3B illustrates a plan view of a multiview display having scattering structures and a global mode mixer in an example consistent with the principles described herein.

FIG. 3C illustrates a perspective view of a multiview display having scattering structures and global mode mixer in an example consistent with the principles described herein.

FIG. 4A illustrates a cross-sectional view of a portion of a planar backlight including a multibeam element fashioned as a diffraction grating and a global mode mixer disposed within a plate waveguide consistent with the principles described herein.

FIG. 4B illustrates a cross-sectional view of a portion of a planar backlight including a multibeam element fashioned as a diffraction grating and a global mode mixer disposed on opposite sides of a plate waveguide consistent with the principles described herein.

FIG. 4C illustrates a cross-sectional view of a portion of a planar backlight including a multibeam element fashioned as a diffraction grating and a global mode mixer disposed on the same side of a plate waveguide consistent with the principles described herein.

FIG. 5 illustrates a plan view of a scattering element with a plurality of scattering sub-elements and a global mode mixer disposed in open spaces between scattering sub-elements according to an example consistent with the principles discussed herein.

FIG. 6 illustrates a flow chart of a method of planar backlight operation consistent with the principles disclosed herein.

Certain examples and embodiments have other features that are one of in addition to and in lieu of the features illustrated in the above-referenced figures. These and other features are detailed below with reference to the above-referenced figures.

### DETAILED DESCRIPTION

Examples and embodiments in accordance with the principles described herein provide a plate waveguide configured to guide light in a plurality of directional modes. The plate light guide includes a global mode mixer disposed along the length of the plate light guide. The global mode mixer is configured to convert a portion of the light guided in a first directional mode into light guided in a second directional mode. The directional modes may have vertical and transverse components. By converting a portion of the light guided in a first directional mode into light guided in a second directional mode, the global mode mixer can improve the light extraction efficiency of the light guide. Such light guides may find use in producing brighter or more efficient backlights for passive displays, for example.

Herein, a “light guide” is defined as a structure that guides light within the structure using total internal reflection. In particular, the light guide may include a core that is substantially transparent at an operational wavelength of the light guide. In various examples, the term ‘light guide’ generally refers to a dielectric optical waveguide that employs total internal reflection to guide light at an interface between a dielectric material of the light guide and a material or medium that surrounds that light guide. By definition, a condition for total internal reflection is that a refractive index of the light guide is greater than a refractive index of a surrounding medium adjacent to a surface of the light guide material. In some embodiments, the light guide may include a coating in addition to or instead of the aforementioned refractive index difference to further facilitate the total internal reflection. The coating may be a reflective coating, for example. The light guide may be any of several light guides including, but not limited to, one or both of a plate or slab guide and a strip guide.

Further herein, the term “plate” when applied to a light guide as in a “plate light guide” is defined as a piece-wise or differentially planar layer or sheet, which is sometimes referred to as a “slab” guide. In particular, a plate light guide is defined as a light guide configured to guide light in two substantially orthogonal directions bounded by a top surface and a bottom surface (i.e., opposite surfaces) of the light guide. Further, by definition herein, the top and bottom surfaces are both separated from one another and may be substantially parallel to one another in at least a differential sense. That is, within any differentially small section of the plate light guide, the top and bottom surfaces are substantially parallel or co-planar.

In some embodiments, the plate light guide may be substantially flat (i.e., confined to a plane) and therefore, the plate light guide is a planar light guide. In other embodiments, the plate light guide may be curved in one or two orthogonal dimensions. For example, the plate light guide may be curved in a single dimension to form a cylindrical shaped plate light guide. However, any curvature has a radius of curvature sufficiently large to ensure that total internal reflection is maintained within the plate light guide to guide light.

As used herein, the term “directional mode” refers to a propagation direction of a light beam or more generally of light that propagates or is guided within a light guide. In general, light propagating in a directional mode within a light guide may be represented by a plurality of orthogonal components including, a longitudinal component, a transverse component, and a vertical component. For example, when using a Cartesian coordinate system, the longitudinal component may be a component of the propagating light in an x-direction within the light guide; the transverse component may be a component of the propagating light in a y-direction within the light guide; and the vertical component may be a component of the propagating light in a z-direction with the light guide.

Further, as used herein, the article ‘a’ is intended to have its ordinary meaning in the patent arts, namely ‘one or more’. For example, ‘a scattering element’ means one or more scattering elements and as such, ‘the scattering element’ means ‘the scattering element(s)’ herein. Also, any reference herein to ‘top’, ‘bottom’, ‘upper’, ‘lower’, ‘up’, ‘down’, ‘front’, back’, ‘first’, ‘second’, ‘left’ or ‘right’ is not intended to be a limitation herein. Herein, the term ‘about’ when applied to a value generally means within the tolerance range of the equipment used to produce the value, or may mean plus or minus 10%, or plus or minus 5%, or plus or minus 1%, unless otherwise expressly specified. Further, the term ‘substantially’ as used herein means a majority, or almost all, or all, or an amount within a range of about 51% to about 100%. Moreover, examples herein are intended to be illustrative only and are presented for discussion purposes and not by way of limitation.

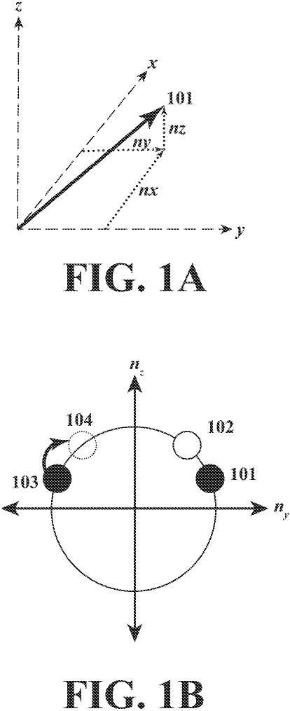

FIG. 1A illustrates a graphical representation of angular components of a light beam having a directional mode in an example according to the principles described herein. The light having a directional mode is represented by a vector depicting a propagation direction.

Further, by definition, light guided in a directional mode within a light guide is constrained to a relationship given by equation (1)

$${n}^{2} = {n}_{x} {}^{2} + {n}_{y} {}^{2} + {n}_{z} {}^{2} \qquad \text{(1)}$$

where n is a vector representing the directional mode with a direction given by the propagation direction and a magnitude equal to an index of refraction of a material of the light guide, and where nₓ, n_{y}, and n_{z} are orthogonal vector components, vector projections or simply components of the vector n. In FIG. 1A, the light having a directional mode represented by vector includes a longitudinal component (nₓ), a transverse component (n_{y}), and a vertical component (n_{z}), as illustrated. As such, the vector component nₓ corresponds to a portion of the directional mode or equivalently of the guided light propagating in the x-direction; the vector component n_{y} corresponds to a portion of the directional mode or equivalently the guided light propagating in the y-direction; and the vector component n_{z} corresponds to a portion of the directional mode or equivalently the guided light propagating in the z-direction.

As light propagates in a light guide light may propagate in many different directional modes. For example, light of a particular directional mode may propagate along the length of the plate light guide in the x-direction and include a transverse component in the y-direction and a vertical component in the z-direction.

FIG. 1B illustrates a graphical representation of directional modes within a light guide in an example, according to an embodiment consistent with the principles described herein. In particular, FIG. 1B represents directional modes plotted in a y-z plane and provides a conceptual illustration of three different directional modes, namely a first directional mode 101, a second directional mode 102, and third directional mode 103. Light propagating or guided in the first directional mode 101 may include light having a first transverse component (n_{y}) and a first vertical component (n_{z}). Light propagating or guided in a second directional mode 102 may include light having a second transverse component (n_{y}) and a second vertical component (n_{z}). As illustrated in FIG. 1B, the first transverse component (n_{y}) of the first directional mode 101 is greater than the second transverse component (n_{y}) of the second directional mode 102. Conversely, the first vertical component (n_{z}) of the first directional mode 101 is less than the vertical component (n_{z}) of the second directional mode 102, as illustrated.

As explained in further detail herein, embodiments of a global mode mixer according to the principles explained herein are configured to convert light of or propagating in one directional mode into light of or propagating in another directional mode. As such, the global mode mixer may convert light of or having a third directional mode 103 into light of or having a fourth directional mode 104 by interacting with the light propagating in the third directional mode 103. FIG. 1B illustrates conversion of the third directional mode 103 into the fourth directional mode 104 using a curved arrow. According to some embodiments, the fourth directional mode 104 may exhibit better or more desirable characteristics than the third directional mode 103. For example, when light is propagating in the fourth directional mode 104 it may exhibit more preferential interaction with a scattering structure of the light guide than the third directional mode as described in further detail herein. As such, mode conversion provided by the global mode mixer may facilitate improved scattering or scattering efficiency by the scattering structure of light propagating within the light guide in the fourth directional mode 104 than would have been achieved for light propagating in third directional mode 103.

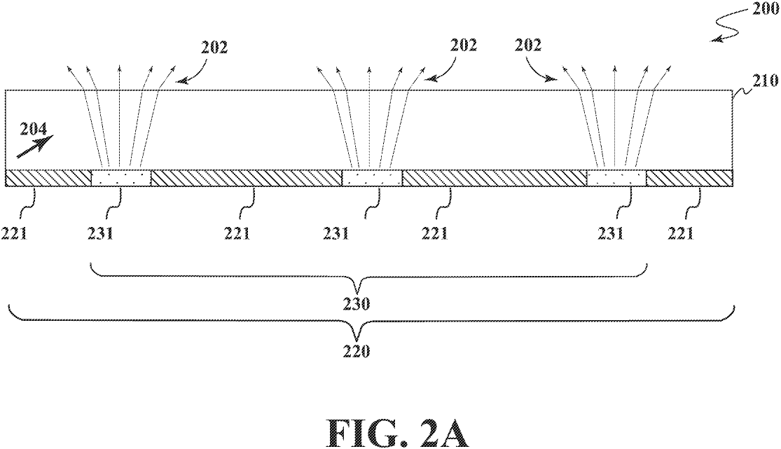

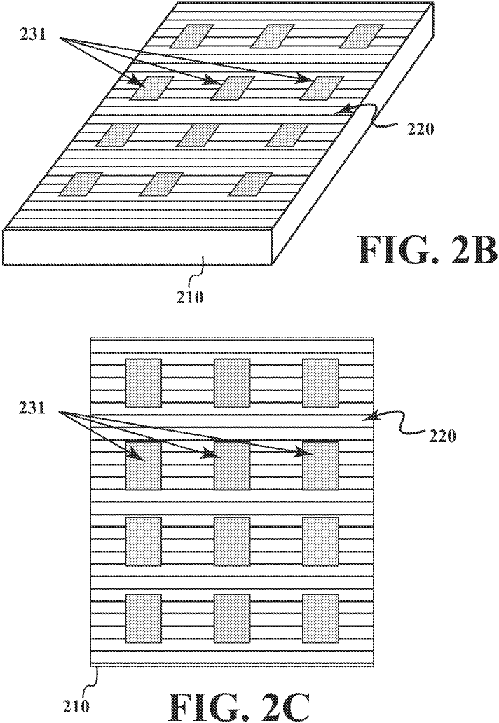

Various illustrations of different views of a planar backlight 200 are shown in FIGS. 2A-2C. While various examples of the concepts disclosed herein are described in connection with a backlight, those skilled in the art will appreciate that the global mode mixer and methods disclosed herein are not limited to use in a backlight and more particularly a multiview backlight, as described in more detail below. The planar backlight 200 may include a plate light guide 210 configured to guide light along the length of the plate light guide. A global mode mixer 220 may extend along a plate waveguide length. In FIGS. 2B and 2C, the global mode mixer 220 is indicated by a series of lines traversing the width of the planar backlight and arranged along the length of the plate light guide 210. While the global mode mixer 220 is disposed on a lower surface of the plate light guide 210 in FIG. 2A, the global mode mixer may be disposed on the upper surface of the plate light guide or may be disposed within the plate light guide, as discussed in further detail below. The global mode mixer 220 can convert a portion of the light guided in the plate light guide 210 (as indicated by arrow) from light guided in a first directional mode into light guided in a second directional mode. The light guided in the first directional mode has one or both of a transverse component that is greater than and a vertical component that is less than respective transverse and vertical components of light guided in the second directional mode. The planar backlight 200 can also include scattering structures including scattering elements 231 formed on or within the plate light guide 210. The scattering elements 231 of the scattering structure are configured to scatter or couple light propagating within the light guide as represented by arrow out of a light guide as emitted light 202. In FIG. 2A light scattered out light is illustrated as emitted light 202 or equivalently scattered-out or coupled-out light beams using arrows.

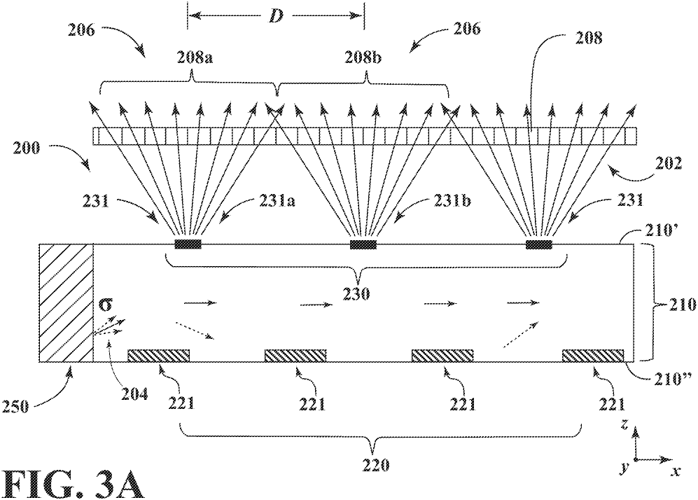

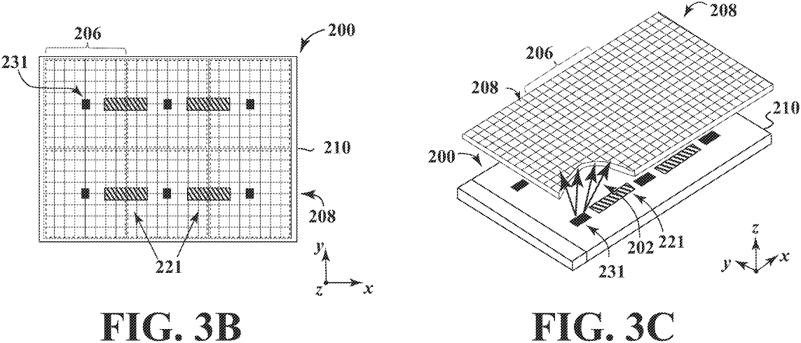

In some embodiments, the planar backlight 200 is configured as a multiview backlight that can provide as the emitted light 202 a plurality of scattered-out or directional light beams having different principal angular directions from one another (e.g., as a light field), as is illustrated in further detail in connection with FIGS. 3A-3C. In particular, the provided plurality of scattered-out or directional light beams of the emitted light 202 may be scattered such that they are directed away from the multiview backlight in different principal angular directions corresponding to respective view directions of a multiview display, according to various embodiments. In some embodiments, the directional light beams of the emitted light 202 may be modulated (e.g., using light valves, as described below) to facilitate the display of information having three-dimensional (3D) or multiview content. Also shown in FIG. 3A are multiview pixels 206 and an array of light valves 208, which are described in more detail below.

FIG. 2A illustrates a cross-sectional view of a planar backlight 200 in an example, according to an embodiment consistent with the principles described herein. FIG. 3A illustrates a cross-sectional view of a multiview display having scattering structures and a global mode mixer in an example consistent with the principles described herein. The multiview display of FIGS. 3A-3C use an example of a planar backlight 200 shown in FIGS. 2A-2C. In FIGS. 2A and 3A, common reference numerals refer to the same structure unless otherwise indicated.

As illustrated in FIG. 2A and FIG. 3A, the planar backlight 200 comprises the plate light guide 210. The plate light guide 210 is configured to guide light along a length of the plate light guide 210 as guided light 204. According to various embodiments, the guided light 204 propagates along a length of the light guide in a plurality of directional modes including a first directional mode and a second directional mode. The plate light guide 210 may include a dielectric material configured as an optical waveguide. The dielectric material may have a first refractive index that is greater than a second refractive index of a medium surrounding the dielectric optical waveguide. The difference in refractive indices is configured to facilitate total internal reflection of the guided light 204 according to one or more guided or directional modes of the plate light guide 210, for example.

In some embodiments, the plate light guide 210 may be a slab or a plate optical waveguide (i.e., a plate light guide) comprising an extended, substantially planar sheet of optically transparent, dielectric material. The substantially planar sheet of dielectric material is configured to guide the guided light 204 (or guided light beam) using total internal reflection. According to various examples, the optically transparent material of the plate light guide 210 may include or be made up of any of a variety of dielectric materials including, but not limited to, one or more of various types of glass (e.g., silica glass, alkali-aluminosilicate glass, borosilicate glass, etc.). In some examples, the plate light guide 210 may further include a cladding layer (not illustrated) on at least a portion of a surface (e.g., one or both of the top surface and the bottom surface) of the plate light guide 210. The cladding layer may be used to further facilitate total internal reflection, according to some examples.

Further, according to some embodiments, the plate light guide 210 is configured to guide the guided light 204 (e.g., as a guided light beam) according to total internal reflection at a non-zero propagation angle between a first surface 210′ (e.g., a ‘front’ surface or side) and a second surface 210″ (e.g., a ‘back’ surface or side) of the plate light guide 210. In some embodiments, a plurality of guided light beams comprising different colors of light may be guided by the plate light guide 210 at respective ones of different color-specific, non-zero propagation angles. Note, light propagating within the plate light guide 210 may propagate along different directions within the plate light guide 210, wherein those directions define the directional modes of propagation of light within the plate light guide 210. It should be understood that the light propagating in each of these different directional modes has a longitudinal component (nₓ), a transverse component (n_{y}), and a vertical component (n_{z}) within the plate light guide 210, as has been previously described.

The guided light 204 in the plate light guide 210 may be introduced or coupled into the plate light guide 210 at a non-zero propagation angle (e.g., about 30-35 degrees). In some examples, a coupling structure such as, but not limited to, a lens, a mirror or similar reflector (e.g., a tilted collimating reflector), a diffraction grating and a prism (not illustrated) as well as various combinations thereof may facilitate coupling light into an input end of the plate light guide 210 as the guided light 204 at the non-zero propagation angle. In other examples, light may be introduced directly into the input end of the plate light guide 210 either without or substantially without the use of a coupling structure (i.e., direct or ‘butt’ coupling may be employed). Once coupled into the plate light guide 210, the guided light 204 is configured to propagate along the plate light guide 210 with a substantial component directed in the longitudinal direction, which is generally away from the input end (e.g., illustrated by bold arrows pointing along an x-axis in FIG. 3A). It should be appreciated, however, that light within the plate light guide 210 may propagate in a plurality of different directional modes, each directional mode being defined by a longitudinal component (nₓ) in the longitudinal or x-direction, transverse component (n_{y}) in the transvers or y-direction, and a vertical component (n_{z}) in the vertical or z-direction.

The light coupled into the plate light guide 210 may be collimated light beam according to certain exemplary implementations of the principles disclosed herein. Herein, a ‘collimated light’ or a ‘collimated light beam’ is generally defined as a beam of light in which rays of the beam of light are substantially parallel to one another within the light beam (e.g., the guided light 204). Further, rays of light that diverge or are scattered from the collimated light beam are not considered to be part of the collimated light beam, by definition herein. In some embodiments, the planar backlight 200 may include a collimator, such as a lens, reflector or mirror, as described above (e.g., tilted collimating reflector) to collimate the light, e.g., from a light source. In some embodiments, the light source comprises a collimator. In this case, the collimated light provided to the plate light guide 210 is a collimated beam of guided light 204.

Herein, a ‘collimation factor’ is defined as a degree to which light is collimated. In particular, a collimation factor defines an angular spread of light rays within a collimated beam of light, by definition herein. For example, a collimation factor σ may specify that a majority of light rays in a beam of collimated light is within a particular angular spread (e.g., +/- σ degrees about a central or principal angular direction of the collimated light beam). The light rays of the collimated light beam may have a Gaussian distribution in terms of angle and the angular spread may be an angle determined by at one-half of a peak intensity of the collimated light beam, according to some examples.

As shown in FIGS. 2A-2C and FIGS. 3A-3C, the planar backlight 200 further comprises a scattering structure 230. According to some embodiments, the scattering structure 230 may be disposed on the first surface 210′ of the plate light guide 210. For example, FIGS. 2A and 3A illustrates the scattering structure 230 on the first surface 210′. In other embodiments, the scattering structure 230 may be disposed on the second surface 210″ of the plate light guide 210. In yet other embodiments, the scattering structure 230 may be located between the first and second surfaces 210′, 210″ within the plate light guide 210. The scattering structure 230 is configured to preferentially scatter out light guided in a second directional mode from the plate light guide 210 as the emitted light 202, according to various embodiments.

The scattering structure 230 may include an array of scattering elements 231 distributed along a length of the plate light guide 210, e.g., along the first or second surfaces 210′, 210″ or within the plate light guide 210. As will be explained in further detail below, the scattering elements 231 constituting the scattering structure 230 may include a plurality of scattering sub-elements (not shown).

The scattering elements 231 of the scattering structure 230 may be separated from each other by a distance and may define distinct elements along the light guide length. That is, by definition herein, the scattering elements 231 of the scattering structure 230 are spaced apart from one another according to a finite (non-zero) inter-element distance (e.g., a finite center-to-center distance). Further, the scattering elements 231 of the plurality generally do not intersect, overlap, or otherwise touch one another, according to some exemplary implementations. That is, each scattering element 231 of the plurality is generally distinct and separated from other ones of the scattering elements 231 according to these examples. In another example, the scattering structure may employ a scattering element disposed continuously along the length of the plate light guide 210 (not shown). As light propagates within the plate light guide 210, the guided light includes light propagating in both a first directional mode and a second directional mode. Guided light 204 in a first directional mode may have one or both of a transverse component that is greater than and a vertical component that is less than respective transverse and vertical components of light guided in a second directional mode, for example. In various embodiments, scattering elements 231 of the scattering structure 230 may be configured and arranged such that the scattering elements 231 preferentially scatter out light of a second directional mode from the plate light guide 210, as mentioned above.

As illustrated in FIGS. 2A and 3A, the planar backlight 200 further comprises a global mode mixer 220. According to various embodiments, global mode mixer 220 is configured to convert a portion of the guided light 204 that is guided in or having the first directional mode into guided light 204 having or guided in the second directional mode. In particular, as light propagates in a propagation direction within the plate light guide 210, the guided light 204 interacts with the global mode mixer 220, which converts the guided light 204 from the first directional mode into light of the second directional mode. In some embodiments, the global mode mixer 220 may be disposed along a length of the plate light guide 210 such that the portions of the guided light 204 in a first directional mode are converted into the second directional mode as the light propagates along the entire length of the plate light guide 210. Light having the first directional mode may be converted by the global mode mixer 220 into light of having the second directional mode by one or both of decreasing transverse component of the guided light portion and increasing a vertical component of the guided light portion, according to some embodiments.

In some embodiments, the global mode mixer 220 may be disposed on a surface of the plate light guide 210 that is opposite side the plate light guide 210 side upon which the scattering structure 230 is disposed. For example, in FIG. 3A the global mode mixer 220 is illustrated on the second surface 210″ of the plate light guide 210, while the scattering structure 230 is located on the first surface 210′, as illustrated. In other embodiments, such as that illustrated in FIGS. 2A-2C, the global mode mixer 220 and the scattering structure 230 may be disposed on the same surface of the plate light guide 210. In yet other embodiments, the global mode mixer 220 may be disposed or located within the plate light guide 210 between the surfaces thereof, as will be discussed in more detail below.

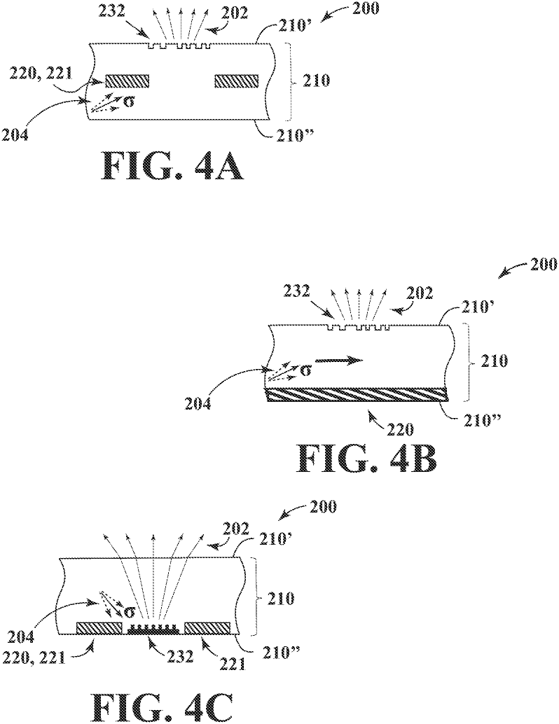

According to some embodiments, global mode mixer 220 includes a plurality of mode mixing elements 221 spaced along the length of the plate light guide 210. In some embodiments, there may be as many mode mixing elements 221 as there are scattering elements 231. Alternatively, there may be a different number of mode mixing elements 221 than scattering elements 231, which is what is shown in FIG. 3A. While the mode mixing elements 221 are illustrated as being discrete elements, it should be understood that the global mode mixer 220 may be implemented as a continuous structure along a length of the plate light guide 210 such as that shown in FIGS. 2A-2C. While not shown, the global mode mixer 220 may be disposed on both of the first and second surfaces 210′, 210″ of the plate light guide 210. As mentioned above, the global mode mixer 220 may also be disposed between the first and second surface 210′, 210″ of the plate light guide 210 in addition to or instead of on one or both of the first and second surfaces 210′, 210″ of the plate light guide 210 as illustrated in FIG. 4A.

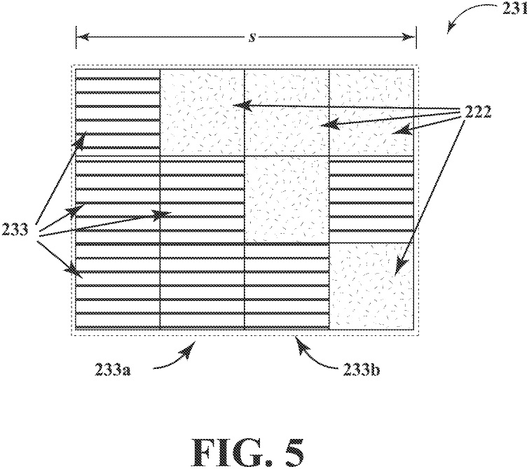

While FIG. 3A shows one exemplary implementation of a global mode mixer 220 disposed opposite from the scattering elements 231 of scattering structure 230, in another implementation, the global mode mixer 220 may be disposed between scattering elements 231 of scattering structure 230 as illustrated, for example in FIGS. 2A-2C. In this implementation, a plurality of scattering elements 231 may be disposed in an array on one surface of the plate light guide 210 and the global mode mixer 220 may be distributed along a length of the plate light guide 210. According to another implementation, the global mode mixer 220 may be disposed within scattering sub-elements (not shown) of individual scattering elements 231 of the scattering structure 230. This type of implementation is described in further detail in connection with FIG. 5.

In some embodiments, the global mode mixer 220 may be implemented as or comprise a diffraction grating. In some embodiments, the diffraction grating may extend across a width and along a length of the plate light guide. When the global mode mixer 220 is implemented as one or more diffraction gratings, the diffractive features of the diffraction grating can be aligned parallel to a propagation direction of the guided light along a plate light guide length. The arrangement of diffractive gratings may be such that a plurality of diffractive gratings are arranged periodically along a length of the light guide.

In other embodiments, the global mode mixer 220 may be implemented as reflective elements having a reflective facet aligned parallel to a propagation direction of the guided light along a plate light guide length. The reflective element may include, for example, a micro-reflector. Alternatively, global mode mixer 220 may be implemented as refractive elements, such as micro-refractors. In still yet other implementations, the global mode mixer 220 may be implemented as a combination of refractive elements, reflective elements and diffractive elements.

According to some embodiments, the scattering elements 231 of the plurality may be arranged in either a one-dimensional (1D) array or a two-dimensional (2D) array. For example, the scattering elements may be arranged as a linear 1D array. In another example, the scattering elements may be arranged as a rectangular 2D array or as a circular 2D array. Such an example of a multiview backlight is illustrated in FIGS. 3B and 3C. Further, the array (i.e., 1D or 2D array) may be a regular or uniform array or may be an irregular array. In particular, if the array is a regular or uniform array, an inter-element distance (e.g., center-to-center distance or spacing) between the scattering elements 231 may be substantially uniform or constant across the array. In the case in which the array is an irregular array, the inter-element distance between the scattering elements may be varied across the array or along the length of the plate light guide 210. Or, the inter-element distance may be varied across and along the length of the plate light guide 210.

According to various embodiments, a scattering element 231 of the scattering structure 230 may comprise a multibeam element. The multibeam elements can be configured to scatter out light guided in the wavelength. In particular, by definition herein, a ‘multibeam element’ is a structure or element of a backlight or a display that produces light that includes a plurality of directional light beams. In some embodiments, the multibeam element may be optically coupled to a light guide of a backlight (e.g., the plate light guide 210 of the planar backlight 200) to provide the plurality of directional light beams by coupling out a portion of light guided in the light guide. In other embodiments, the multibeam element may generate light emitted as the light beams (e.g., may comprise a light source). Further, the light beams of the plurality of directional light beams produced by a multibeam element have different principal angular directions from one another, by definition herein. In particular, by definition, a directional light beam of the plurality has a predetermined principal angular direction that is different from another directional light beam of the directional light beam plurality. Furthermore, the directional light beam plurality may represent a light field. For example, the directional light beam plurality may be confined to a substantially conical region of space or have a predetermined angular spread that includes the different principal angular directions of the light beams in the light beam plurality. As such, the predetermined angular spread of the directional light beams in combination (i.e., the light beam plurality) may represent the light field.

According to various embodiments, the different principal angular directions of the various directional light beams of the plurality are determined by a characteristic including, but not limited to, a size (e.g., length, width, area, etc.) of the multibeam element. In some embodiments, the multibeam element may be considered an ‘extended point light source’, i.e., a plurality of point light sources distributed across an extent of the multibeam element, by definition herein. According to various examples, the multibeam elements may include one or more of diffraction gratings, micro-reflective elements, or micro-refractive elements. An example of a diffraction grating according to several examples is shown in FIGS. 4A-4C.

Herein, a ‘diffraction grating’ is generally defined as a plurality of features (i.e., diffractive features) arranged to provide diffraction of light incident on the diffraction grating. In some examples, the plurality of features may be arranged in a periodic or quasi-periodic manner. For example, the diffraction grating may include a plurality of features (e.g., a plurality of grooves or ridges in a material surface) arranged in a one-dimensional (1D) array. In other examples, the diffraction grating may be a two-dimensional (2D) array of features. The diffraction grating may be a 2D array of bumps on or holes in a material surface, for example.

As such, and by definition herein, the ‘diffraction grating’ is a structure that provides diffraction of light incident on the diffraction grating. If the light is incident on the diffraction grating from a light guide, the provided diffraction or diffractive scattering may result in, and thus be referred to as, ‘diffractive coupling’ in that the diffraction grating may couple light out of the light guide by diffraction. The diffraction grating also redirects or changes an angle of the light by diffraction (i.e., at a diffractive angle). In particular, as a result of diffraction, light leaving the diffraction grating generally has a different propagation direction than a propagation direction of the light incident on the diffraction grating (i.e., incident light). The change in the propagation direction of the light by diffraction is referred to as ‘diffractive redirection’ herein. Hence, the diffraction grating may be understood to be a structure including diffractive features that diffractively redirects light incident on the diffraction grating and, if the light is incident from a light guide, the diffraction grating may also diffractively couple out the light from the light guide.

Further, by definition herein, the features of a diffraction grating are referred to as ‘diffractive features’ and may be one or more of at, in and on a material surface (i.e., a boundary between two materials). The surface may be a surface of a light guide, for example. The diffractive features may include any of a variety of structures that diffract light including, but not limited to, one or more of grooves, ridges, holes and bumps at, in or on the surface. For example, the diffraction grating may include a plurality of substantially parallel grooves in the material surface. In another example, the diffraction grating may include a plurality of parallel ridges rising out of the material surface. The diffractive features (e.g., grooves, ridges, holes, bumps, etc.) may have any of a variety of cross sectional shapes or profiles that provide diffraction including, but not limited to, one or more of a sinusoidal profile, a rectangular profile (e.g., a binary diffraction grating), a triangular profile and a saw tooth profile (e.g., a blazed grating).

According to various examples described herein, a diffraction grating (e.g., a diffraction grating of a multibeam element, as described below) may be employed to diffractively scatter or couple light out of a light guide (e.g., a plate light guide) as a light beam. In particular, a diffraction angle θₘ of or provided by a locally periodic diffraction grating may be given by equation (2) as:

$${θ}_{m} = {sin}^{- 1} \left(n sin {θ}_{i} - \frac{m λ}{d}\right) \qquad \text{(2)}$$

where λ is a wavelength of the light, m is a diffraction order, n is an index of refraction of a light guide, d is a distance or spacing between features of the diffraction grating, θᵢ is an angle of incidence of light on the diffraction grating. For simplicity, equation (2) assumes that the diffraction grating is adjacent to a surface of the light guide and a refractive index of a material outside of the light guide is equal to one (i.e., nₒᵤₜ = 1). In general, the diffraction order m is given by an integer. A diffraction angle θₘ of a light beam produced by the diffraction grating may be given by equation (2) where the diffraction order is positive (e.g., m > 0). For example, first-order diffraction is provided when the diffraction order m is equal to one (i.e., m = 1).

FIGS. 4A-4C illustrate cross-sectional views of a portion of a planar backlight 200 including a multibeam element 232 fashioned as a diffraction grating and a global mode mixer 220 disposed at various locations in or on the plate light guide 210. As shown in FIGS. 4A-4C scattered-out directional light beams of the emitted light 202 as a plurality of divergent arrows depicted as being directed away from the first (or front) surface 210′ of the plate light guide 210. Further, according to various embodiments, a size of multibeam element 232 may be comparable to a size of a light valve 208 in a multiview display (or equivalently, a sub-pixel in a multiview pixel of a multiview display), as described herein. The multiview pixels 206 are illustrated in FIGS. 3A-3C with the planar backlight 200 for the purposes of facilitating discussion. The “size” may be defined in a variety of manners to include, but not limited to, a length, a width or an area.

In some embodiments, the size of the multibeam element is comparable to the light valve size such that the diffraction grating size is between about twenty-five percent (25%) and about two hundred percent (200%) of the light valve size. In other examples, the multibeam element size is in a range that is greater than about fifty percent (50%) of the light valve size, or greater than about sixty percent (60%) of the light valve size, or greater than about seventy percent (70%) of the light valve size, or greater than about eighty percent (80%) of the light valve size, and that is less than about one hundred eighty percent (180%) of the light valve size, or less than about one hundred sixty percent (160%) of the light valve size, or less than about one hundred forty (140%) of the light valve size, or less than about one hundred twenty percent (120%) of the light valve size. According to some embodiments, the comparable sizes of the multibeam element and the light valve may be chosen to reduce, or in some examples to minimize, dark zones between views of the multiview display. Moreover, the comparable sizes of the multibeam element and the light valve may be chosen to reduce, and in some examples to minimize, an overlap between views (or view pixels) of a multiview display or of a multiview image displayed by the multiview display.

FIGS. 3A-3C also illustrate an array of light valves 208 configured to modulate the directional light beam plurality of the emitted light 202. The light valve array may be part of a multiview display that employs the planar backlight 200 configured as a multiview backlight, for example, and is illustrated in FIGS. 3A-3C for purposes of facilitating discussion herein. In FIG. 3C, the array of light valves 208 is partially cut-away to allow visualization of the plate light guide 210 and scattering element 231 and mode mixing elements 221 of the global mode mixer underlying the light valve array, for discussion purposes only.

As illustrated in FIGS. 3A-3C, different ones of the directional light beams of the emitted light 202 having different principal angular directions pass through and may be modulated by different ones of the light valves 208 in the light valve array. Further, as illustrated a light valve 208 of the array corresponds to a sub-pixel of the multiview pixel 206, and a set of the light valves 208 corresponds to a multiview pixel 206 of the multiview display. In particular, a different set of light valves 208 of the light valve array is configured to receive and modulate the directional light beams from a corresponding one of the scattering elements 231 configured as a multibeam element, i.e., there may be one unique set of light valves 208 for each scattering element 231, as illustrated. In various embodiments, different types of light valves may be employed as the light valves 208 of the light valve array including, but not limited to, one or more liquid crystal light valves, electrophoretic light valves, and light valves based on electrowetting.

As illustrated in FIG. 3A, a first light valve set 208a is configured to receive and modulate the directional light beams of the emitted light 202 from a first scattering element 231a. Further, a second light valve set 208b is configured to receive and modulate the directional light beams of the emitted light 202 from a second scattering element 231b. Thus, in this example, each of the light valve sets (e.g., the first and second light valve sets 208a, 208b) in the light valve array corresponds, respectively, both to a different scattering element 231 (e.g., first and second elements 231a, 231b) and to a different multiview pixel 206, with individual light valves 208 of the light valve sets corresponding to the sub-pixels of the respective multiview pixels 206, as illustrated in FIG. 3A.

Note that, as illustrated in FIG. 3A, the size of a sub-pixel of a multiview pixel 206 may correspond to a size of a light valve 208 in the light valve array. In other examples, the light valve size or the sub-pixel size may be defined as a distance (e.g., a center-to-center distance) between adjacent light valves in the light valve array. The sub-pixel size may be defined as either the size of the light valve 208 or a size corresponding to the center-to-center distance between the light valves 208, for example.

In some exemplary implementations, a relationship between the scattering elements 231 and corresponding multiview pixels 206 (i.e., sets of sub-pixels and corresponding sets of light valves 208) may be a one-to-one relationship. That is, there may be an equal number of multiview pixels 206 and scattering elements 231. FIG. 3B shows by way of example the one-to-one relationship where each multiview pixel 206 comprising a different set of light valves 208 (and corresponding sub-pixels) is illustrated as surrounded by a dashed line. In other embodiments (not illustrated), the number of multiview pixels 206 and the number of scattering elements 231 may differ from one another.

In some embodiments, an inter-element distance (e.g., center-to-center distance) between a pair of scattering elements 231 of the plurality may be equal to an inter-pixel distance (e.g., a center-to-center distance) between a corresponding pair of multiview pixels 206, e.g., represented by light valve sets. For example, as illustrated in FIG. 3A, a center-to-center distance between the first scattering element 231a and the second scattering element 231b is substantially equal to a center-to-center distance D between the first light valve set 208a and the second light valve set 208b. In other embodiments (not illustrated), the relative center-to-center distances of pairs of scattering elements 231 and corresponding light valve sets may differ, e.g., the scattering elements 231 may have an inter-element spacing (i.e., center-to-center distanced) that is one of greater than or less than a spacing (i.e., center-to-center distance D) between light valve sets representing multiview pixels 206.

In some embodiments, a shape of the scattering element 231 is analogous to a shape of the multiview pixel 206 or equivalently, to a shape of a set (or ‘sub-array’) of the light valves 208 corresponding to the multiview pixel 206. For example, the scattering element 231 may have a square shape and the multiview pixel 206 (or an arrangement of a corresponding set of light valves 208) may be substantially square. In another example, the scattering element 231 may have a rectangular shape, i.e., may have a length or longitudinal dimension that is greater than a width or transverse dimension. In this example, the multiview pixel 206 (or equivalently the arrangement of the set of light valves 208) corresponding to the scattering element 231 may have an analogous rectangular shape. FIG. 3B illustrates a top or plan view of square-shaped scattering elements 231 and corresponding square-shaped multiview pixels 206 comprising square sets of light valves 208. In yet other examples (not illustrated), the scattering elements 231 and the corresponding multiview pixels 206 have various shapes including or at least approximated by, but not limited to, a triangular shape, a hexagonal shape, and a circular shape.

Further (e.g., as illustrated in FIG. 3A), each scattering element 231 is configured to provide directional light beams of the emitted light 202 to one and only one multiview pixel 206, according to some embodiments. In particular, for a given one of the scattering elements 231, the directional light beams of the emitted light 202 having different principal angular directions corresponding to the different views of the multiview display are substantially confined to a single corresponding multiview pixel 206 and the sub-pixels thereof, i.e., a single set of light valves 208 corresponding to the scattering element 231, as illustrated in FIG. 3A. As such, each scattering element 231 of the planar backlight 200 provides a corresponding set of directional light beams of the emitted light 202 that has a set of the different principal angular directions corresponding to the different views of the multiview display (i.e., the set of directional light beams of the emitted light 202 contains a light beam having a direction corresponding to each of the different view directions).

As illustrated in FIGS. 4A-4C and according to various embodiments, a scattering element of the scattering structure may comprise a multibeam element 232. In some embodiments, the multibeam element 232 may comprise a diffraction grating (e.g., as illustrated in FIGS. 4A-4C). In some embodiments, one or more (e.g., each) multibeam element 232 may comprise a plurality of diffraction gratings. The multibeam element 232, or more particularly the plurality of diffraction gratings of the diffractive multibeam element 232, may be located either on, at or adjacent to a surface of the plate light guide 210 or between the light guide surfaces. In other embodiments, the multibeam element 232 may be located between a first surface 210′ and a second surface 210″ of the plate light guide 210.

FIG. 4A illustrates a cross-sectional view of a portion of a planar backlight 200 including a multibeam element 232 formed as a diffraction grating and a mode mixing element 221 of a global mode mixer 220 disposed within the plate light guide 210. Here, the plate light guide 210 may be fabricated such that the global mode mixer is disposed between the first surface 210′ of the plate light guide and a second surface 210″ of the plate light guide. The mode mixing element 221 is configured to convert light of a first directional mode into light of a second directional mode, where the second directional mode is preferentially scattered out of the plate light guide 210 by scattering multibeam element 232 or another multibeam element of the scattering element (not shown). The emitted light 202 scattered out of the plate light guide 210 is illustrated by directional arrows in FIG. 4A.

FIG. 4B illustrates a cross-sectional view of a portion of a planar backlight 200 including a multibeam element 232 and a portion of a global mode mixer 220 in an example, according to an embodiment consistent with the principles described herein. As illustrated in FIG. 4B, the multibeam element 232 is at the first surface 210′ of the plate light guide 210. Further, the multibeam element 232 illustrated in FIG. 4B comprises a plurality of diffraction gratings, by way of example and not limitation. When located at the first surface 210′ of the plate light guide 210, a diffraction grating of the grating plurality may be a transmission mode diffraction grating configured to diffractively couple out the guided light portion through the first surface 210′ as emitted light 202 or directional light beams, for example. Multibeam elements 232 can be configured to preferentially scatter out light guided in a second directional mode (e.g., the second directional mode 102, as described above) from the plate light guide 210 as the directional light beams or emitted light 202 comprising directional light beams having directions corresponding to view directions of views of a multiview image as explained in further detail below. The portion of the global mode mixer 220 illustrated in FIG. 4B is shown as extending along the lower surface of the entirety of the segment of the plate light guide 210 show. It will be understood that the global mode mixer 220 according to this example may extend along substantially the entire length of the lower surface of the plate light guide 210.

FIG. 4C illustrates a cross-sectional view of a portion of a planar backlight 200 including a multibeam element 232 fashioned as a diffraction grating and a portion of a global mode mixer 220 including mode mixing elements 221 disposed on the same side of the plate light guide 210 as the multibeam element 232. In this example, the global mode mixer 220 includes mode mixing elements 221 disposed such that they are distributed in spaces between spaced-apart scattering elements, such as the multibeam elements 232. Other configurations and arrangements of elements of the global mode mixer and scattering structure are discussed elsewhere, such as in connection with the examples illustrated in FIG. 5 and described below.

When located at the second surface 210″, a diffraction grating constituting a multibeam element 232 may be a reflection mode diffraction grating, for example. As a reflection mode diffraction grating, the diffraction grating is configured to both diffract the guided light portion and reflect the diffracted guided light portion toward the first surface 210′ to exit through the first surface 210′ as the diffractively coupled-out light beams. In other embodiments (not illustrated), the diffraction grating may be located between the surfaces of the plate light guide 210, e.g., as one or both of a transmission mode diffraction grating and a reflection mode diffraction grating. Note that, in some embodiments described herein, the principal angular directions of the coupled-out light beams may include an effect of refraction due to the coupled-out light beams exiting the plate light guide 210 at a light guide surface. For example, FIG. 4C illustrates, by way of example and not limitation, refraction (i.e., bending) of the coupled-out light beams of the emitted light 202 due to a change in refractive index as the coupled-out light beams cross the first surface 210′.

According to some embodiments, the diffractive features of a diffraction grating may comprise one or both of grooves and ridges that are spaced apart from one another. The grooves or the ridges may comprise a material of the plate light guide 210, e.g., may be formed in a surface of the plate light guide 210. In another example, the grooves or the ridges may be formed from a material other than the light guide material, e.g., a film or a layer of another material on a surface of the plate light guide 210.

In some embodiments, a diffraction grating is a uniform diffraction grating in which the diffractive feature spacing is substantially constant or unvarying throughout the diffraction grating. In other embodiments, the diffraction grating is a chirped diffraction grating. By definition, the ‘chirped’ diffraction grating is a diffraction grating exhibiting or having a diffraction spacing of the diffractive features (i.e., the grating pitch) that varies across an extent or length of the chirped diffraction grating. In some embodiments, the chirped diffraction grating may have or exhibit a chirp of the diffractive feature spacing that varies linearly with distance. As such, the chirped diffraction grating is a ‘linearly chirped’ diffraction grating, by definition. In other embodiments, the chirped diffraction grating may exhibit a non-linear chirp of the diffractive feature spacing. Various non-linear chirps may be used including, but not limited to, an exponential chirp, a logarithmic chirp or a chirp that varies in another, substantially nonuniform or random but still monotonic manner. Non-monotonic chirps such as, but not limited to, a sinusoidal chirp or a triangle or sawtooth chirp, may also be employed. Combinations of any of these types of chirps may also be employed.

According to various embodiments, the diffraction gratings may be arranged in a number of different configurations to couple out a portion of the guided light 204 as the plurality of coupled-out light beams. In particular, the plurality of diffraction gratings of the multibeam element 232 may comprise a first diffraction grating and a second diffraction grating as illustrated in more detail in connection with FIG. 5.

The first diffraction grating may be configured to provide a first light beam of the plurality of scattered-out or coupled-out light beams as emitted light 202, while the second diffraction grating may be configured to provide a second light beam of the plurality of scattered-out or coupled-out light beams as emitted light 202. According to various embodiments, the first and second light beams may have different principal angular directions. Moreover, the plurality of diffraction gratings may comprise a third diffraction grating, a fourth diffraction grating and so on, each diffraction grating being configured to provide a different coupled-out light beam, according to some embodiments. In some embodiments, one or more of the diffraction gratings of the diffraction grating plurality may provide more than one of the coupled-out light beams.

FIG. 5 illustrates a plan view of a scattering element 231 including global mode mixing elements 222 according to an embodiment consistent with the principles described herein. The scattering element 231 may comprise a plurality of scattering sub-elements 233 including, for example, a first scattering sub-element 233a and a second scattering sub-element 233b. The scattering sub-elements 233 of the plurality may be formed on a surface (e.g., first and second surfaces 210′, 210″) of the plate light guide 210 or may be disposed within the plate light guide 210. According to certain examples, the scattering element 231 may be a multibeam element, and the multibeam element may comprise a plurality of diffraction gratings. The scattering sub-elements 233, such as 233a and 233b may be independent from one another and exhibit different grating properties. A size s of the scattering element 231 is illustrated in FIG. 5, and a boundary of the scattering element 231 is shown with a dashed line. In the case in which the scattering element 231 is a multibeam element comprising a plurality of diffraction gratings, each of the diffraction gratings may have one or more of the characteristics described above. For example, one or more of the diffraction gratings of the plurality of diffraction gratings may be chirped while other diffraction gratings are not chirped.

The scattering element 231 may have a plurality of scattering sub-elements 233 and also include spaces without scattering sub-elements. Global mode mixing elements 222 may be disposed within these spaces without scattering sub-elements such that the global mode mixer is disposed, at least in part, within scattering elements 231 of the planar backlight. Some or all of the scattering sub-elements 233 may have curved diffractive features. Those skilled in the field would recognize that a variety of structures could be used to define scattering sub-elements including, for example, grooves, ridges, holes and bumps at, in or on the surface.

According to some embodiments, a differential density of scattering sub-elements 233 within a scattering element 231 may be configured to control a relative intensity of the plurality of directional light beams of the emitted light 202, coupled out by respective different scattering elements 231. In other words, the scattering elements 231 may have different densities of scattering sub-elements 233 therein and the different densities (i.e., the differential density of the scattering sub-elements) may be configured to control the relative intensity of the plurality of coupled-out light beams (e.g., 202). In particular, a scattering element 231 having fewer scattering sub-elements 233 within the plurality of scattering sub-elements may produce a plurality of coupled-out light beams having a lower intensity (or beam density) than another scattering element 231 having relatively more scattering sub-elements 233. The differential density of scattering sub-elements 233 may be provided using locations such as locations corresponding to the global mode mixing elements 222 illustrated in FIG. 5 within the diffractive multibeam element. While all of the area of the scattering element 231 is shown as being occupied either by a scattering sub-element 233 or a global mode mixing element 222, it should be appreciated that some spaces within the scattering element may include neither structure.

The differential density of the scattering sub-elements 233 within the scattering element leaves certain open spaces within the scattering element 231. A global mode mixer can be disposed in the open spaces left by the differential spacing technique such that some or all of the open spaces within the differentially spaced scattering sub-elements 233 within the scattering element are left open. FIG. 5 shows an example in which the global mode mixer is disposed in spaces among the scattering sub-elements 233 of the scattering element 231.

Referring again to FIG. 3A, the planar backlight 200 may further comprise a light source 250. According to various embodiments, the light source 250 is configured to provide the light to be guided within the plate light guide 210. In particular, the light source 250 may be located adjacent to an entrance surface or end (input end) of the plate light guide 210. In various embodiments, the light source 250 may comprise substantially any source of light (e.g., optical emitter) including, but not limited to, a light emitting diode (LED), a laser (e.g., laser diode) or a combination thereof. In some embodiments, the light source 250 may comprise an optical emitter configured produce a substantially monochromatic light having a narrowband spectrum denoted by a particular color. In particular, the color of the monochromatic light may be a primary color of a particular color space or color model (e.g., a red-green-blue (RGB) color model). In other examples, the light source 250 may be a substantially broadband light source configured to provide substantially broadband or polychromatic light. For example, the light source 250 may provide white light. In some embodiments, the light source 250 may comprise a plurality of different optical emitters configured to provide different colors of light. The different optical emitters may be configured to provide light having different, color-specific, non-zero propagation angles of the guided light corresponding to each of the different colors of light. According to various embodiments, scattering feature spacing and other scattering characteristics (e.g., periodicity of scattering features such as bumps, holds, gratings, etc.) as well as orientation of such features relative to a propagation direction of the guided light may correspond to the different colors of light. In other words, a scattering element 231 may comprise various scattering elements of the scattering element plurality that may be tailored to different colors of the guided light, for example.

In some embodiments, the light source 250 may further comprise a collimator. The collimator may be configured to receive substantially uncollimated light from one or more of the optical emitters of the light source 250. The collimator is further configured to convert the substantially uncollimated light into collimated light. In particular, the collimator may provide collimated light having the non-zero propagation angle and being collimated according to a predetermined collimation factor, according to some embodiments. Moreover, when optical emitters of different colors are employed, the collimator may be configured to provide the collimated light having one or both of different, color-specific, non-zero propagation angles and having different color-specific collimation factors. The collimator is further configured to communicate the collimated light beam to the plate light guide 210 to propagate as the guided light 204, described above.

In some embodiments, the planar backlight 200 is configured to be substantially transparent to light in a direction through the plate light guide 210 that is orthogonal to (or substantially orthogonal) to a propagation direction of the guided light 204. In particular, the plate light guide 210 and the spaced-apart scattering elements 231 (e.g., diffractive multibeam elements) of the scattering structure 230 allow light to pass through the plate light guide 210 through both the first surface 210′ and the second surface 210″, in some embodiments. Transparency may be facilitated, at least in part, due to both the relatively small size of the scattering elements 231 and the relatively large inter-element spacing (e.g., one-to-one correspondence with the multiview pixels 206) of the scattering structure 230. Further, the scattering elements 231 of the scattering structure 230 may be substantially transparent to light propagating orthogonal to the first and second light guide surfaces 210′, 210″, according to some embodiments.

In accordance with some embodiments of the principles described herein, a multiview display is provided. The multiview display is configured to emit modulated light beams as pixels of the multiview display. The emitted, modulated light beams have different principal angular directions from one another (also referred to as ‘differently directed light beams’ herein). Further, the emitted, modulated light beams may be preferentially directed toward a plurality of viewing directions of the multiview display. In non-limiting examples, the multiview display may include four-by-eight (4 × 8) or eight-by-eight (8 × 8) views with a corresponding number of view directions. In some examples, the multiview display is configured to provide or ‘display’ a 3D or multiview image. Different ones of the modulated, differently directed light beams may correspond to individual pixels of different views associated with the multiview image, according to various examples. The different views may provide a ‘glasses free’ (e.g., autostereoscopic) representation of information in the multiview image being displayed by the multiview display, for example.

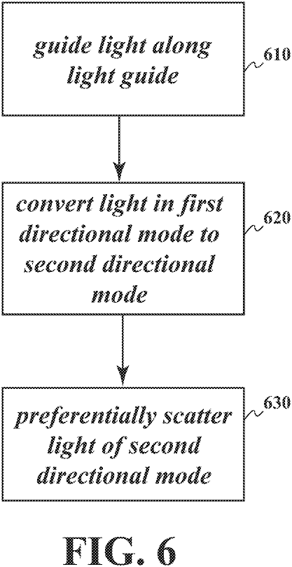

FIG. 6 illustrates a flow chart of a method of planar backlight operation consistent with principles disclosed herein. A method of planar backlight operation can include guiding light as guided light generally along a length of a light guide 610. The guided light may include at least a first directional mode and a second directional mode. As the light is guided down the length of the light guide, a portion of the light guided in a first directional mode is converted into light of a second directional mode 620 using a global mode mixer extending along a length of the plate light guide. The method of planar backlight operation can further include preferentially scattering light out of the light guide 630 using a scattering structure to provide emitted light. The scattering structure is configured such that it preferentially scatters light propagating in the second directional mode out of the light guide. The light guided in the first directional mode can have one or both of a transverse component that is greater than and a vertical component that is less than respective transverse and vertical components of light guide din the second directional mode. According to various embodiments, the global mode mixer converts the guided light portion in the first directional mode into guided light in the second directional mode comprising one or both of decreasing a transverse component of the guided light portion and increasing a vertical component of the guided light portion.

As used in the method of planar backlight operation, the global mode mixer may be implemented as a diffraction grating. In such embodiments, the diffraction grating may extend along a length and across a width of a light guide such as a plate light guide. In such a case, the diffractive features of the diffraction grating are aligned parallel to a propagation direction of the guided light along the plate light guide length. Instead of or in combination with diffractive features, the global mode mixer can perform mode mixing using a reflective element having a reflective facet aligned parallel to a propagation direction of the guided light along the plate light guide length. The method may further include the use of a scattering structure comprising an array of scattering elements that are spaced apart along a length of the light guide. In such a method, the conversion of the light from the first directional mode to the second directional mode may be performed using a global mode mixer that is disposed between spaced-apart scattering elements of the scattering element.

Other aspects of the exemplary methods include the use of a scattering structure that comprises an array of multibeam elements. Each of the multibeam elements can scatter out the guided light in the second directional mode from the light guide as the emitted light comprising directional light beams having directions corresponding to view directions of views of a multiview image, the method of planar backlight operation further comprising modulating the directional light beams of the emitted light to provide the multiview image.

What is claimed is:

1. A planar backlight comprising:
a plate light guide configured to guide light along a length of the plate light guide as guided light;
a global mode mixer extending along the plate light guide length, the global mode mixer being configured to convert a portion of the light guided in a first directional mode into light guided in a second directional mode; and
a scattering structure configured to preferentially scatter out the light guided in the second directional mode from the plate light guide as emitted light,
wherein the light guided in the first directional mode has one or both of a transverse component that is greater than and a vertical component that is less than respective transverse and vertical components of the light guided in the second directional mode.

2. The planar backlight of claim 1, wherein the global mode mixer is configured to convert the guided light portion in the first directional mode into guided light in the second directional mode comprising one or both of decreasing a transverse component of the guided light portion and increasing a vertical component of the guided light portion.

3. The planar backlight of claim 1, wherein the global mode mixer is disposed on a surface of the plate light guide.

4. The planar backlight of claim 3, wherein the scattering structure is disposed on a surface of the plate light guide opposite to the surface on which the global mode mixer is disposed.

5. The planar backlight of claim 1, wherein the global mode mixer comprises a diffraction grating extending across a width and along the length of the plate light guide, diffractive features of the diffraction grating being aligned parallel to a propagation direction of the guided light along the plate light guide length.

6. The planar backlight of claim 1, wherein the global mode mixer comprises a reflective element having a reflective facet aligned parallel to a propagation direction of the guided light along the plate light guide length.

7. The planar backlight of claim 1, wherein the scattering structure comprises an array of scattering elements spaced apart from one another along the plate light guide length, the global mode mixer being distributed between spaced-apart scattering elements of the scattering element array.

8. The planar backlight of claim 7, wherein a scattering element of the scattering element array comprises a plurality of scattering sub-elements, the global mode mixer further being distributed within the scattering element between scattering sub-elements of the scattering sub-element plurality.

9. The planar backlight of claim 7, wherein scattering elements of the scattering element array comprise multibeam elements, each multibeam element being configured to scatter out the guided light in the second directional mode from the plate light guide as the emitted light comprising directional light beams having directions corresponding to view directions of views of a multiview image.

10. The planar backlight of claim 9, wherein each multibeam element comprises one or more of a diffraction grating, a micro-reflective element, and a micro-refractive element.

11. A multiview display comprising the planar backlight of claim 9, the multiview display further comprising an array of light valves configured to modulate the directional light beams of the emitted light to provide the multiview image, wherein the multibeam elements have a size that is between twenty-five percent and two hundred percent of a size of a light valve of the light valve array.

12. A multiview backlight comprising:
a plate light guide configured to guide light as guided light;
an array of multibeam elements disposed along a length of the plate light guide, each multibeam element being configured to scatter the guided light out of the plate light guide as emitted light comprising directional light beams having directions corresponding to directions of different views of a multiview image; and
a global mode mixer distributed between multibeam elements of the multibeam element array, the global mode mixer being configured to convert light guided according to a first directional mode into light guided according to a second directional mode,
wherein each multibeam element is configured to preferentially scatter out light guided according to the second directional mode relative to light guided according to the first directional mode.

13. The multiview backlight of claim 12, wherein light guided according to the first directional mode comprises light having one or both of:
a transverse component that is greater than a transverse component of light guided according to the second directional mode; and
a vertical component that is less than a vertical component of light guided according to the second directional mode,
wherein the global mode mixer is configured to convert light guided according to the first directional mode into light guided according to the second directional mode comprising one or both of decreasing a transverse component and increasing a vertical component of the guided light.

14. The multiview backlight of claim 12, wherein global mode mixer is disposed on a surface of the plate light guide, the multibeam element array being disposed adjacent to the surface on which the global mode mixer is disposed.

15. The multiview backlight of claim 12, wherein the global mode mixer comprises a diffraction grating extending across a width and along the length of the plate light guide between multibeam elements of the multibeam element array, diffractive features of the diffraction grating being aligned parallel to a propagation direction of the guided light along the plate light guide length.

16. The multiview backlight of claim 12, wherein the global mode mixer comprises one or both of a reflective element and a refractive element, the reflective element having a reflective facet aligned parallel to a propagation direction of the guided light along the plate light guide length, the global mode mixer extending across a width and along the length of the plate light guide between multibeam elements of the multibeam element array.

17. A multiview display comprising the multiview backlight of claim 12, the multiview display further comprising an array of light valves configured to modulate the directional light beams of the emitted light to provide the multiview image, wherein the multibeam elements have a size that is between twenty-five percent and two hundred percent of a size of a light valve of the light valve array.

18. A method of planar backlight operation, the method comprising:
guiding light in a propagation direction along a length of a plate light guide as guided light;
converting a portion of light guided in a first directional mode into light guided in a second directional mode using a global mode mixer extending along the plate light guide length; and
scattering the guided light out of the plate light guide using a scattering structure to provide emitted light, the scattering structure preferentially scattering out light guided in the second directional mode,
wherein the light guided in the first directional mode has one or both of a transverse component that is greater than and a vertical component that is less than respective transverse and vertical components of the light guided in the second directional mode.

19. The method of planar backlight operation of claim 18, wherein the global mode mixer converts the guided light portion in the first directional mode into guided light in the second directional mode comprising one or both of decreasing a transverse component of the guided light portion and increasing a vertical component of the guided light portion.

20. The method of planar backlight operation of claim 18, wherein the global mode mixer comprises one or both of:
a diffraction grating extending across a width and along the length of the plate light guide, diffractive features of the diffraction grating being aligned parallel to the propagation direction of the guided light along the plate light guide length; and
a reflective element having a reflective facet aligned parallel to the propagation direction of the guided light along the plate light guide length.

21. The method of planar backlight operation of claim 18, wherein the scattering structure comprises an array of scattering elements spaced apart from one another along the plate light guide length, the global mode mixer being distributed between spaced-apart scattering elements of the scattering element array.

22. The method of planar backlight operation of claim 18, wherein the scattering structure comprises an array of multibeam elements, each multibeam element scattering out the guided light in the second directional mode from the plate light guide as the emitted light comprising directional light beams having directions corresponding to view directions of views of a multiview image, the method of planar backlight operation further comprising modulating the directional light beams of the emitted light to provide the multiview image.
